(19) United States
(12) Patent Application Publication
(10) Pub. No.: US 2023/0379892 A1
(43) Pub. Date: Nov. 23, 2023

(54) TIME SEGMENT REQUEST METHOD AND APPARATUS, TIME SEGMENT CONFIGURATION METHOD AND APPARATUS

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/025,059

(22) PCT Filed: Sep. 7, 2020
(86) PCT No.: PCT/CN2020/113844

§ 371 Date: Mar. 7, 2023

(51) Int. Cl. H04W 72/0446

(52) U.S. Cl. CPC H04W 72/0446; H04W 88/06

(57) ABSTRACT

Provided are time segment request methods, time segment configuration methods, electronic devices and computer readable storage media, the time segment request method includes: receiving time segment configuration information from a network side device; in response to determining that the second SIM is to communicate with a second base station during communication between a first SIM and a first base station, controlling the first SIM to communicate with the first base station and controlling the second SIM to communicate with the second base station based on the time segment configuration information. It is not necessary to completely interrupt a communication connection between the first SIM and the first base station in order to communicate with the second base station via the second SIM, which is conducive to improving communication efficiency of the terminal.

### CROSS-REFERENCE TO RELATED APPLICATION

The present application is a U.S. National Stage of International Application No. PCT/CN2020/113844 filed on Sep. 7, 2020, the entire content of which is incorporated herein by reference for all purposes.

### TECHNICAL FIELD

The present disclosure relates to communication technologies and, in particular to time segment request methods and apparatuses, time segment configuration methods and apparatuses, electronic devices, and computer readable storage media.

### BACKGROUND

A multi-SIM terminal refers to a terminal that can contain multiple Subscriber Identity Modules (SIMs). The multiple SIMs may belong to a same operator or to different operators.

In a communication process of the multi-SIM terminal, there are often cases that the multiple SIMs need to communicate at the same time. For example, when a first SIM is in communication with a first base station, a second SIM is determined to need to communicate with a second base station. In this case, how to meet communication needs of both of the two SIMs at the same time becomes a problem that expected to be solved.

### SUMMARY

In view of the above, embodiments of the present disclosure provide time segment request methods and apparatuses, time segment configuration methods and apparatuses, electronic devices, and computer readable storage media to solve technical problems in related art.

According to a first aspect of embodiments of the present disclosure, there is provided a time segment request method, the method is performed by a terminal configured with at least a first SIM and a second SIM, and the method includes: receiving time segment configuration information from a network side device; and in response to determining that the second SIM is to communicate with a second base station during communication between the first SIM and a first base station, controlling the first SIM to communicate with the first base station and controlling the second SIM to communicate with the second base station, based on the time segment configuration information.

According to a second aspect of the embodiments of the present disclosure, there is provided a time segment configuration method, the method is performed by a first base station and includes transmitting time segment configuration information to a terminal. The time segment configuration information is for indicating that the terminal controls a first Subscriber Identity Module (SIM) to communicate with the first base station and controls a second SIM to communicate with a second base station based on the time segment configuration information in response to determining that the second SIM is to communicate with the second base station during communication between the first SIM and the first base station.

According to a third aspect of the embodiments of the present disclosure, there is provided a time segment configuration method, the method is performed by a second base station and includes transmitting time segment configuration information to a terminal. The time segment configuration information is for indicating that the terminal controls a first Subscriber Identity Module (SIM) to communicate with a first base station and controls a second SIM to communicate with the second base station based on the time segment configuration information in response to determining that the second SIM is to communicate with the second base station during communication between the first SIM and the first base station.

According to a fourth aspect of embodiments of the present disclosure, there is provided an electronic device, including: a processor, and a memory for storing processor-executable instructions; where the processor is configured to implement any one of the above time segment request methods and/or the time segment configuration methods.

According to a fifth aspect of embodiments of the present disclosure, there is provided a computer readable storage medium storing a computer program, where the program is executed by a processor to implement steps of any one of the above time segment request methods and/or the time segment configuration methods.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without inventive efforts.

FIG. 1 is a schematic flowchart illustrating a time segment request method according to an embodiment of the present disclosure.

FIG. 2 is a schematic flowchart illustrating another time segment request method according to an embodiment of the present disclosure.

FIG. 3 is a schematic flowchart illustrating another time segment request method according to an embodiment of the present disclosure.

FIG. 4 is a schematic flowchart illustrating another time segment request method according to an embodiment of the present disclosure.

FIG. 5 is a schematic flowchart illustrating another time segment request method according to an embodiment of the present disclosure.

FIG. 6 is a schematic flowchart illustrating a time segment configuration method according to an embodiment of the present disclosure.

FIG. 7 is a schematic flowchart illustrating another time segment configuration method according to an embodiment of the present disclosure.

FIG. 8 is a schematic flowchart illustrating another time segment configuration method according to an embodiment of the present disclosure.

FIG. 9 is a schematic flowchart illustrating another time segment configuration method according to an embodiment of the present disclosure.

FIG. 10 is a schematic flowchart illustrating another time segment configuration method according to an embodiment of the present disclosure.

FIG. 11 is a schematic flowchart illustrating another time segment configuration method according to an embodiment of the present disclosure.

FIG. 12 is a schematic flowchart illustrating another time segment configuration method according to an embodiment of the present disclosure.

FIG. 13 is a schematic flowchart illustrating another time segment configuration method according to an embodiment of the present disclosure.

FIG. 14 is a schematic flowchart illustrating another time segment configuration method according to an embodiment of the present disclosure.

FIG. 15 is a schematic flowchart illustrating another time segment configuration method according to an embodiment of the present disclosure.

FIG. 16 is a schematic flowchart illustrating another time segment configuration method according to an embodiment of the present disclosure.

FIG. 17 is a schematic flowchart illustrating another time segment configuration method according to an embodiment of the present disclosure.

FIG. 18 is a schematic block diagram illustrating a time segment request apparatus according to an embodiment of the present disclosure.

FIG. 19 is a schematic block diagram illustrating another time segment request apparatus according to an embodiment of the present disclosure.

FIG. 20 is a schematic block diagram illustrating another time segment request apparatus according to an embodiment of the present disclosure.

FIG. 21 is a schematic block diagram illustrating a time segment configuration apparatus according to an embodiment of the present disclosure.

FIG. 22 is a schematic block diagram illustrating another time segment configuration apparatus according to an embodiment of the present disclosure.

FIG. 23 is a schematic block diagram illustrating another time segment configuration apparatus according to an embodiment of the present disclosure.

FIG. 24 is a schematic block diagram illustrating another time segment configuration apparatus according to an embodiment of the present disclosure.

FIG. 25 is a schematic block diagram illustrating an apparatus for time segment configuration according to an embodiment of the present disclosure.

FIG. 26 is a schematic block diagram illustrating an apparatus for time segment request according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely some examples of the present disclosure rather than all of the embodiments. All other embodiments obtained by a person of ordinary skill in the art based on the embodiments of the present disclosure without creative efforts shall fall within the protection scope of the present disclosure.

According to the embodiments of the present disclosure, in a process of communication between a first SIM and a first base station, when determining that a second SIM is to communicate with a second base station, according to time segment configuration information, both communication between the first base station and the first SIM and communication between the second base station and the second SIM are possible within a period of time, and it is not necessary to completely interrupt a communication connection between the first SIM and the first base station in order to communicate with the second base station via the second SIM, which is conducive to improving communication efficiency of a terminal.

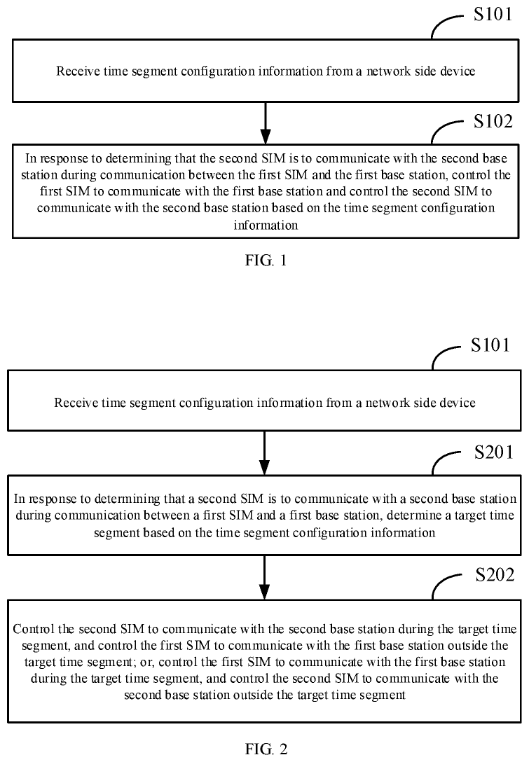

FIG. 1 is a schematic flowchart illustrating a time segment request method according to an embodiment of the present disclosure. The time segment request method shown in this embodiment may be performed by a terminal, and the terminal includes, but is not limited to, electronic devices such as cell phones, tablets, wearable devices, sensors, IoT devices and so on. The terminal may communicate with a base station as a user equipment, and the base station includes, but is not limited to, a 4G base station, a 5G base station, a 6G base station, or a base station of any generation of communication system. In an embodiment, the base station may be a base station at which a time segment configuration method described in any of the subsequent embodiments is performed.

With at least a first SIM and a second SIM configured in the terminal, the terminal can be considered as a multi-SIM terminal. For example, the terminal can be selectively implemented as multi-SIM-multi-standby, multi-SIM-single-active, multi-SIM-multi-active, and so on. The multiple SIMS can access a network of the same operator or networks of different operators, which can be configured as needed.

As shown in FIG. 1, the time segment request method may include the following steps S101 and S102.

At step S101, time segment configuration information from a network side device is received.

In an embodiment, a terminal is configured with a first SIM and a second SIM, and the first SIM can communicate with a first base station and the second SIM can communicate with a second base station. Optionally, the first base station and the second base station may be a same base station or may be different base stations. Optionally, radio access technology types of the first base station and the second base station may be identical, such as both being 4G base stations; or, the radio access technology types of the first base station and the second base station may be different, such as one being a 4G base station and the other being a 5G base station. Optionally, the first base station and the second base station may belong to a same operator, or may belong to different operators.

In an embodiment, the network side device may transmit time segment configuration information to the terminal. The network side device may be the first base station and/or the second base station as described above, or may be one or more core networks corresponding to the first base station and/or the second base station. After receiving the time segment configuration information from the network side device, the terminal may save the time segment configuration information.

At step S102, during communication between the first SIM and the first base station, in response to determining that the second SIM is to communicate with the second base station, the first SIM is controlled to communicate with the first base station, and the second SIM is controlled to communicate with the second base station, both based on the time segment configuration information.

In an embodiment, during the communication between the first SIM and the first base station, if the second SIM needs to communicate with the second base station, for example, if the second SIM receives a paging message transmitted by the second base station and needs to respond to the paging message, or if the second SIM needs to perform operations such as transmitting and receiving information with the second base station, the terminal can control the first SIM to communicate with the first base station and control the second SIM to communicate with the second base station based on the time segment configuration information. It should be noted that the above determining that the second SIM is to communicate with the second base station refers to the terminal determining that a communication with the second base station will be needed when the terminal has not made that communication with the second base station yet, such as when the terminal receives a request from the second base station and determines that the request needs to be responded to, or when the terminal needs to transmit information to the base station, and so on.

Accordingly, in a process of communication between a first SIM and a first base station, when determining that communication with a second base station via a second SIM is needed, according to time segment configuration information, both communication between the first base station and the first SIM and communication between the second base station and the second SIM are possible within a period of time, and it is not necessary to completely interrupt a communication connection between the first SIM and the first base station in order to communicate with the second base station via the second SIM, which is conducive to improving communication efficiency of a terminal.

FIG. 2 is a schematic flowchart illustrating another time segment request method according to an embodiment of the present disclosure. As shown in FIG. 2, based on time segment configuration information, a first SIM is controlled to communicate with a first base station, and a second SIM is controlled to communicate with a second base station, which includes the following steps S101, S201 and S202.

At step S201, a target time segment is determined based on the time segment configuration information.

At step S202, the second SIM is controlled to communicate with the second base station within the target time segment, and the first SIM is controlled to communicate with the first base station outside the target time segment; or, the first SIM is controlled to communicate with the first base station within the target time segment, and the second SIM is controlled to communicate with the second base station outside the target time segment.

In an embodiment, the target time segment is for indicating a time period in which a terminal allows the second SIM to communicate with the second base station. Within the target time segment, the second SIM communicates with the second base station; and outside the target time segment, the first SIM communicates with the first base station.

In an embodiment, the target time segment is for indicating a time period in which the terminal allows the first SIM to communicate with the first base station. Within the target time segment, the first SIM is controlled to communicate with the first base station, and outside the target time segment, the second SIM is controlled to communicate with the second base station.

The following is an example using the target time segment as a time period for indicating the terminal to allow the second SIM to communicate with the second base station.

In an embodiment, the target time segment may be configured as cyclical time periods, for each cycle, the second SIM communicates with the second base station during the time period, and the first SIM communicates with the first base station during the time out of the time period. Optionally, the target time segment may also be configured with a number of cycles, and the above steps may be performed for each cycle within the number of cycles.

In an embodiment, the target time segment may be configured as one or more cyclical time periods, and the terminal may periodically control the first SIM and the second SIM to communicate according to the target time segment. For example, the target time segment is 0 ms-500 ms within 1000 ms, then for each cycle, e.g., 1000 ms, the terminal controls the second SIM to communicate with the second base station in first 500 ms, and controls the first SIM to communicate with the first base station in subsequent 500 ms.

In an embodiment, the target time segment may be configured with cyclical time periods and a number of cycles, and then the terminal controls the first SIM and the second SIM to communicate periodically according to the number of cycles. For example, the target time segment is 0 ms-500 ms within 1000 ms of 10 cycles. Then for each of the ten cycles, e.g., ten 1000 ms, the terminal controls the second SIM to communicate with the second base station in the first 500 ms and controls the first SIM to communicate with the first base station in the subsequent 500 ms. After completing communications in the cycles based on the number of cycles, for example after 10 cycles as described above, the terminal continues to control the first SIM to communicate with the first base station and no longer controls the second SIM to communicate with the second base station.

In an embodiment, the target time segment may be configured with a limited duration and one or more cyclical time periods, during the limited duration, the first SIM and the second SIM are periodically controlled to communicate with base stations, and after the limited duration, the second SIM is stopped from being controlled to communicate with the second base station. For example, the target time segment is further configured to be used within 10 seconds, then within the 10 seconds duration, the second SIM is controlled to communicate with the second base station within the target time segment, and meanwhile the first SIM is controlled to communicate with the first base station outside the target time segment.

It should be noted that the above embodiments are merely example illustrations, and in practice, other ways of setting a target time segment may be used, or a combination of the above embodiments may also be used, without limitation here. For a target time segment for indicating a time period when the terminal allows the first SIM to communicate with the first base station, the method of setting the target time segment can be referred to the above-mentioned embodiment and will not be repeated here.

Accordingly, the terminal may receive time segment configuration transmitted by a base station, and based on the time segment configuration, during communication between the first SIM and the first base station, control the first SIM to communicate with the first base station and control the second SIM to communicate with the second base station in response to determining that the second SIM is to communicate with the second base station. For the target time segment for indicating the time when the terminal allows the second SIM to communicate with the second base station, the first SIM suspends communication with the first base station within the target time segment to allow the second SIM to use the target time segment to communicate with the second base station; and outside the target time segment, the first SIM is still controlled to communicate with the first base station. For the target time segment for indicating the time when the terminal allows the first SIM to communicate with the first base station, within the target time segment, the first SIM communicates with the first base station using the target time segment; outside the target time segment, the first SIM suspends the communication with the first base station and the second SIM is controlled to communicate with the second base station. In this way, the first SIM and the second SIM communicate alternately using different time periods, which is equivalent to realization of different SIMS communicating with base stations at same time, and improving communication efficiency of the terminal.

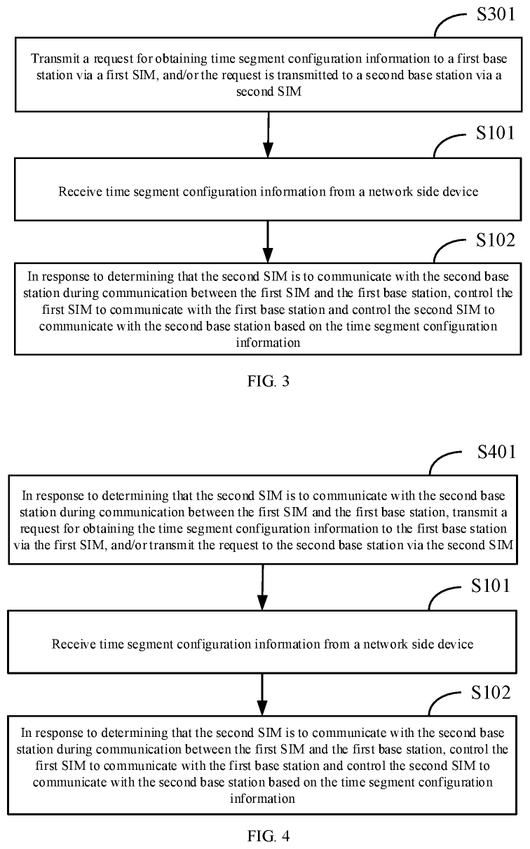

FIG. 3 is a schematic flowchart illustrating another time segment request method according to an embodiment of the present disclosure.

As shown in FIG. 3, the method further includes the following step S301 along with steps S101 and S102.

At step S301, a request for obtaining time segment configuration information is transmitted to a first base station via a first SIM, and/or the request is transmitted to a second base station via a second SIM.

In an embodiment, a terminal may transmit the request for obtaining the time segment configuration information to the first base station via the first SIM. After receiving the request, the first base station may transmit the time segment configuration information to the terminal, or the first base station may further transmit a negotiation request to the second base station, causing the second base station to transmit the time segment configuration information to the terminal.

In an embodiment, the terminal may transmit the request for obtaining the time segment configuration information to the second base station via the second SIM. After receiving the request, the second base station may transmit the time segment configuration information to the terminal, or the second base station may further transmit a negotiation request to the first base station, causing the first base station to transmit the time segment configuration information to the terminal.

It is noted that an order of performing step S301 and step S102 may be set as needed. For example, step S301 may be performed before step S102 as described in FIG. 3, in which case the time segment configuration information used in step S102 may be the time segment configuration information received from the base station after transmitting the request in step S301.

The performing order can also be adjusted as needed, such as performing step S301 after step S102, in which case the time segment configuration information used in step S102 can be pre-stored by the terminal or received from a base station after the terminal transmits a request to the base station to obtain the time segment configuration last time.

FIG. 4 is a schematic flowchart illustrating another time segment request method according to an embodiment of the present disclosure. As shown in FIG. 4, a request for obtaining time segment configuration information is transmitted to a first base station via a first SIM, and/or the request is transmitted to a second base station via a second SIM, which includes the following step S401 along with steps S101 and S102.

At step S401, during communication between the first SIM and the first base station, in response to determining that the second SIM is to communicate with the second base station, a request for obtaining the time segment configuration information is transmitted to the first base station via the first SIM, and/or the request is transmitted to the second base station via the second SIM.

In an embodiment, during the communication between the first SIM and the first base station, in response to determining that the second SIM also needs to communicate with the second base station, a terminal may be triggered to transmit a request for obtaining the time segment configuration information to a base station.

It should be noted that a trigger condition for the terminal to transmit the request for obtaining time segment configuration information to a base station in this step may be similar to a trigger condition for the terminal to control the communication between the first SIM and the second SIM based on the time segment configuration information in step S102.

In an embodiment, this step may be associated with performing of step S401 and step S102 when the above trigger condition is met. For example, during the communication between the first SIM and the first base station, in response to determining that the second SIM is to communicate with the second base station, the terminal may first transmit a request for obtaining time segment configuration information to the first base station and/or the second base station, and then control the first SIM to communicate with the first base station, and control the second SIM to communicate with the second base station based on the received time segment configuration information.

In an embodiment, the request for obtaining time segment configuration information transmitted by the terminal to the base station may be carried in an existing interactive signaling, such as a measurement report signaling, where the measurement report signaling is a modified measurement report signaling; or it may be carried in a newly introduced radio resource control (RRC) signaling to be transmitted.

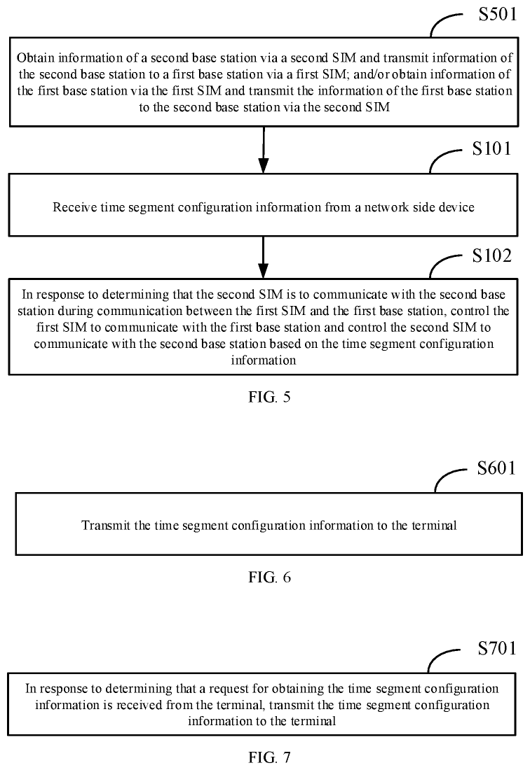

FIG. 5 is a schematic flowchart illustrating another time segment request method according to an embodiment of the present disclosure. As shown in FIG. 5, the method further includes the following step S501 along with S101 and S102.

At step S501, information of a second base station is transmitted to a first base station via a first SIM; and/or information of a first base station is transmitted to a second base station via a second SIM.

In an embodiment, a base station may negotiate with another base station in order to determine a time segment. For example, after the first base station receives a request for obtaining time segment configuration information, the first base station is to negotiate with the second base station. To negotiate with the second base station, the first base station first needs to establish a communication connection with the second base station, so it is also necessary for a terminal to transmit information of the second base station to the first base station for the first base station to determine the second base station and thus establish a communication connection with the second base station.

For example, after the second base station receives the request for obtaining the time segment configuration information, the second base station may negotiate with the first base station. To negotiate with the first base station, the second base station first needs to establish a communication connection with the first base station, so it is also necessary for the terminal to transmit the information of the first base station to the second base station for the second base station to determine the first base station and thus establish a communication connection with the first base station.

In an embodiment, the terminal can transmit the information of the second base station to the first base station via the first SIM, and can also transmit the information of the first base station to the second base station via the second SIM.

When the terminal transmits information of another base station to one of the first base station and the second base station, the information of base station can be carried in the request for obtaining the time segment configuration to transmit, or it can also be transmitted by another signaling. Optionally, the information of the base station, may be carried in an existing interactive signaling, such as a measurement report signaling, where the measurement report signaling is a modified measurement report signaling; or may be carried in a newly introduced radio resource control RRC signaling to be transmitted, which is not limited in this embodiment.

In an embodiment, the terminal can transmit the information of the second base station to the first base station via the first SIM.

The terminal first obtains the information of the second base station via the second SIM, and transmits the information of the second base station to the first SIM via the second SIM. Then the first SIM transmits the information of the second base station to the first base station.

Optionally, the method further includes the following: transmitting the information of the second base station to the first SIM via the second SIM; and/or, transmitting the information of the first base station to the second SIM via the first SIM.

In an embodiment, in the case of transmitting the information of the second base station to the first base station via the first SIM, the information of the second base station may first be transmitted to the first SIM via the second SIM. For example, the information may be directly transmitted from the second SIM to the first SIM, or it may first be transmitted from the second SIM to a processor of the terminal and then transmitted from the processor to the first SIM. In the case of transmitting the information of the first base station to the second base station via the second SIM, the information of the first base station may first be transmitted to the second SIM via the first SIM. For example, the information may be directly transmitted from the first SIM to the second SIM, or it may be transmitted from the first SIM to the processor of the terminal and then transmitted from the processor to the second SIM.

Optionally, the information of the second base station includes at least one of: an identifier (ID) of the base station, a communication technology type of the base station, or configuration information of the base station.

After receiving the information of the second base station, the first base station may determine the second base station indicated by the information of the second base station, then establish a communication connection with the second base station, and negotiate with the second base station to determine the time segment configuration information. Further, the first base station and/or the second base station may transmit negotiated time segment configuration information to the terminal.

Accordingly, after receiving the information of the first base station, the second base station may determine the first base station indicated by the information of the first base station, then establish a communication connection with the first base station, and negotiate with the first base station to determine the time segment configuration information. Further, the first base station and/or the second base station may transmit negotiated time segment configuration information to the terminal.

At this point, the process on a terminal side is completed. According to the above process, when a first SIM communicates with a first base station, in response to determining that a second SIM needs to communicate with a second base station, a terminal can communicate with the base stations based on time segment configuration transmitted by a base station, ensuring that different SIMS can use different time intervals to communicate with one or more base stations respectively, realizing that multiple SIMS communicate with one or more base stations at same time, which can ensure that communication tasks corresponding to multiple SIMS can all be performed normally and improve communication efficiency of the terminal.

FIG. 6 is a schematic flowchart illustrating a time segment configuration method according to an embodiment of the present disclosure. The time segment configuration method shown in this embodiment can be performed by a base station, the base station includes, but is not limited to, a 4G base station, a 5G base station, a 6G base station, or a base station of any generation of communication system. The base station may be a first base station in the above embodiments, communicating with a terminal and a second base station in the above embodiments, the terminal including but not limited to a cell phone, a tablet, a wearable device, a sensor, an IoT device, and other electronic devices. In an embodiment, the terminal may be a terminal performing a time segment request method as described in any of the above embodiments.

As shown in FIG. 6, the time segment configuration method may include the following step S601. At step S601, time segment configuration information is transmitted to the terminal.

The time segment configuration information is for indicating that the terminal controls a first SIM to communicate with a first base station and controls a second SIM to communicate with a second base station based on the time segment configuration information when determining that the second SIM is to communicate with the second base station during communication between the first SIM and the first base station.

In an embodiment, the first base station may transmit time segment configuration information to the terminal. After receiving the time segment configuration information, the terminal may process a situation in which that the second SIM needs to communicate with the second base station is determined during the communication between the first base station and the first SIM based on the time segment configuration information. Specifically, during the communication between the first SIM and the first base station, in response to determining that the second SIM is to communicate with the second base station, the terminal controls the first SIM to communicate with the first base station and controls the second SIM to communicate with the second base station based on the time segment configuration information.

Accordingly, in a process of communication between a first SIM and a first base station, when determining that a second SIM is to communicate with a second base station, a terminal can implement both the communication between the first base station and the first SIM and communication between the second base station and the second SIM within a period of time according to time segment configuration information, and it is not necessary to completely interrupt a communication connection between the first SIM and the first base station in order to communicate with the second base station via the second SIM, which is conducive to improving communication efficiency of the terminal.

FIG. 7 is a schematic flowchart illustrating another time segment configuration method according to an embodiment of the present disclosure.

As shown in FIG. 7, time segment configuration information is transmitted to a terminal includes the following step S701. At step S701, in response to determining that a request for obtaining the time segment configuration information is received from the terminal, the time segment configuration information is transmitted to the terminal.

In an embodiment, the terminal may transmit the request for obtaining the time segment configuration information to a first base station via a first SIM. After receiving the request, the first base station transmits the time segment configuration information to the terminal. Or, the first base station may further transmit a negotiation request to a second base station, causing the second base station to transmit the time segment configuration information to the terminal. Or, the first base station may also transmit the time segment configuration information to the terminal based on a returned negotiation result after transmitting the negotiation request to the second base station.

FIG. 8 is a schematic flowchart illustrating another time segment configuration method according to an embodiment of the present disclosure.

As shown in FIG. 8, the method further includes the following steps S801-S803 along with S601.

At step S801, information of a second base station transmitted from a terminal is received.

In an embodiment, a base station may negotiate with another base station in order to determine a time segment. For example, after receiving a request for obtaining time segment configuration information, a first base station needs to negotiate with the second base station. To negotiate with the second base station, the first base station first needs to establish communication with the second base station, so it is also necessary to obtain information of the second base station from the terminal.

In an embodiment, the terminal can transmit the information of the second base station to the first base station via the first SIM. The first base station receives the information of the second base station transmitted from the terminal. Optionally, the terminal may carry the information of the second base station in the request for obtaining the time segment configuration information; or, the terminal may also transmit the information of the second base station via a separate signaling.

In an embodiment, the information of the second base station includes at least one of: an ID of the base station, a communication technology type of the base station, or configuration information of the base station.

At step S802, the second base station is determined based on the information of the second base station.

In an embodiment, after receiving the information of the second base station, the first base station may determine the second base station indicated by the information. For example, the first base station may determine the second base station indicated by the identifier of the base station, based on the identifier of the base station.

In an embodiment, if the first base station determines that the second base station indicated by the information of the second base station, is the same base station as the first base station, the time segment configuration information is determined directly based on information of the first base station, first service information corresponding to communication between the first SIM and the first base station and/or second service information corresponding to communication between a second SIM and the second base station, and sends the determined time segment configuration information to the terminal.

At step S803, the time segment configuration information is determined in negotiation with the second base station.

In an embodiment, after receiving the information of the second base station, the first base station may determine the second base station indicated by the information of the second base station, then establish a communication connection with the second base station, and negotiate with the second base station to determine the time segment configuration information.

In an embodiment, the first base station may establish an Xn interface with the second base station and negotiate with the second base station through a signaling of the Xn interface. Optionally, the first base station and the second base station can also establish separate interfaces with a core network and communicate with the core network separately, and then the first base station and the second base station can negotiate via the core network.

In an embodiment, a negotiation process between the first base station and the second base station may be carried out during a process of establishing an interface connection, e.g., during the process of establishing an Xn interface between the first base station and the second base station by carrying a negotiation request and a response message in an Xn Setup Request signaling and an Xn Setup Response signaling. Optionally, the negotiation process between the first base station and the second base station may also be performed through relevant signalings after the establishing of the interface connection is completed.

It is noted that after the first base station and the second base station negotiate to determine the time segment configuration information, the first base station may selectively implement the step of transmitting the time segment configuration information to the terminal. For example, the determined time segment configuration information may be transmitted to the terminal by the first base station, or the determined time segment configuration information may be transmitted to the terminal by the second base station, or both the first base station and the second base station may transmit the time segment configuration information to the terminal. As for which base station to transmit the time segment configuration information to the terminal, it can be determined by the negotiation between the first base station and the second base station, and is not limited in this embodiment.

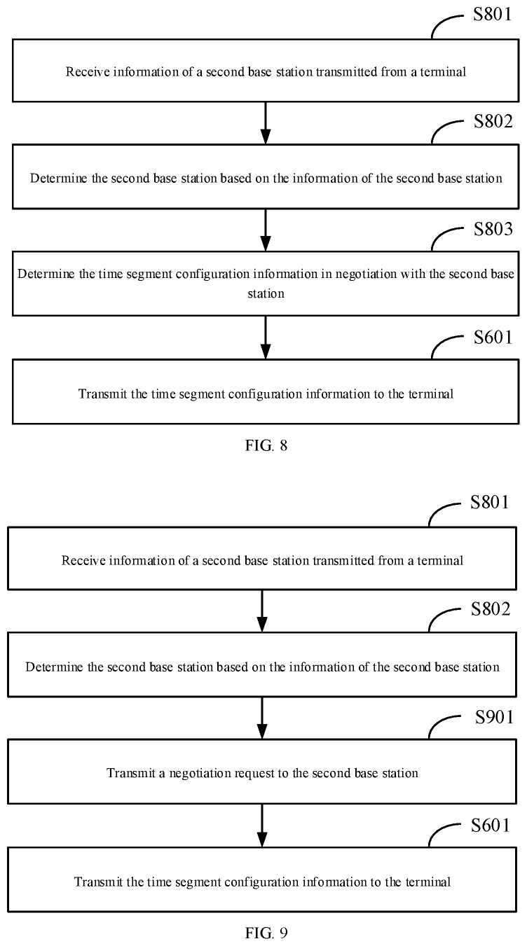

FIG. 9 is a schematic flowchart illustrating another time segment configuration method according to an embodiment of the present disclosure.

As shown in FIG. 9, the time segment configuration information is determined in negotiation with the second base station includes the following step S901 along with steps S801, S802 and S601.

At step S901, a negotiation request is transmitted to the second base station.

The negotiation request is for requesting the second base station to determine the time segment configuration information.

In an embodiment, after receiving information of the second base station from a terminal, if a first base station determines that the second base station is not a same base station as the first base station, the first base station may establish a communication connection with the second base station and then transmit a negotiation request to the second base station, after the second base station receives the negotiation request, the time segment configuration information may be determined.

In an embodiment, the first base station may also transmit first service information corresponding to communication between a first SIM and the first base station to the second base station, and the negotiation request is for requesting the second base station to determine the time segment configuration information based on the first service information, and second service information corresponding to communication between a second SIM and the second base station.

After receiving the negotiation request, the second base station, on the one hand, determines the second service information corresponding to the communication between the second SIM and the second base station, and on the other hand, receives the first service information corresponding to the communication between the first SIM and the first base station transmitted by the first base station. Based on the first service information and the second service information, the second base station can determine the time segment configuration information.

For example, the second base station can determine the time segment configuration information based on the importance of the service. For example, in response to determining that a second service indicated by the second service information is of higher importance than a first service indicated by the first service information, the second base station may determine a time segment of a larger length, such as 0-700 ms out of 1000 ms, such that the terminal may perform the second service using a sufficient length of time when communicating with the second base station via the second SIM. Optionally, the second base station may also determine the time segment configuration information based on communication time needed for the first service and the second service, or may be determined by other information in practice, which is not limited in this embodiment.

In an embodiment, the second base station may determine the time segment configuration information based on information of the first base station and the information of the second base station. For example, configuration information of the base station may include performance of the base station (e.g., traffic transmission rate, and so on), and then the second base station may determine the time segment configuration information based on the performance of the first base station and the second base station.

The second base station can also combine the information of the base station as well as information of a service to determine the time segment configuration information, and the specific implementation can be determined according to practical needs, which will not be repeated here.

In an embodiment, after determining the time segment configuration information, the second base station may transmit the time segment configuration information to the first base station. After receiving the time segment configuration information, the first base station can directly send the time segment configuration information to the terminal; or the first base station can also confirm the time segment configuration information, and transmit confirmation information to the second base station to instruct the second base station to send the time segment configuration information to the terminal, and so on. A specific process for determining the time segment configuration information is illustrated here by way of example only and is not limited.

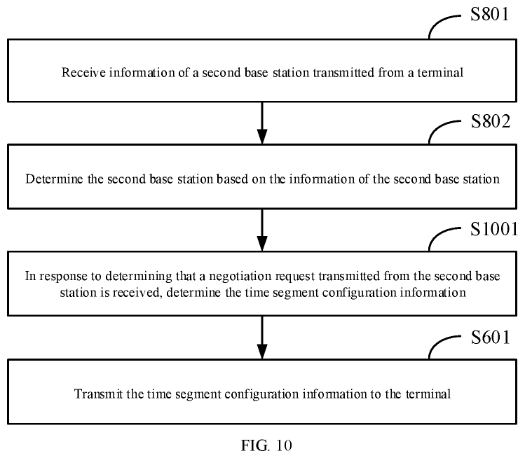

FIG. 10 is a schematic flowchart illustrating another time segment configuration method according to an embodiment of the present disclosure.

As shown in FIG. 10, the time segment configuration information is determined in negotiation with the second base station includes the following step S1001 along with steps S801, S802 and S601.

At step S1001, in response to determining that a negotiation request transmitted from the second base station is received, the time segment configuration information is determined.

In an embodiment, after receiving information of a first base station from a terminal, if the second base station determines that the first base station and the second base station are not a same base station, the second base station may establish a communication connection with the first base station and thus transmit a negotiation request to the first base station. After receiving the negotiation request, the first base station may determine the time segment configuration information.

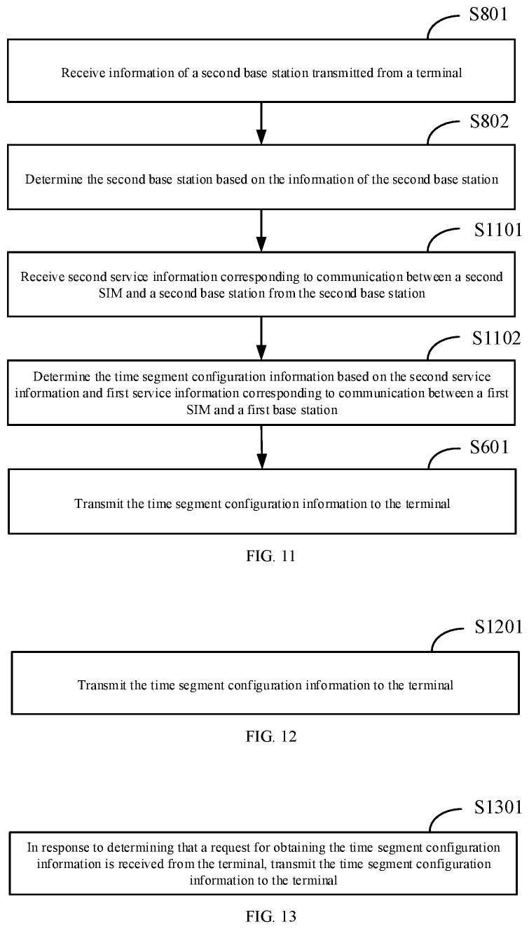

FIG. 11 is a schematic flowchart illustrating another time segment configuration method according to an embodiment of the present disclosure.

As shown in FIG. 11, the method further includes the following steps S1101 and S1102 along with steps S801, S802 and S601.

At step S1101, second service information corresponding to communication between a second SIM and a second base station is received from the second base station.

Determining time segment configuration information includes the following.

At step S1102, the time segment configuration information is determined based on the second service information and first service information corresponding to communication between a first SIM and a first base station.

In an embodiment, after receiving information of a first base station from a terminal, the second base station may also transmit the second service information corresponding to the communication between the second SIM and the second base station to the first base station. After receiving a negotiation request, the first base station, on the one hand, determines the first service information corresponding to the communication between the first SIM and the first base station, and on the other hand, receives the second service information corresponding to the communication between the second SIM and the second base station transmitted by the second base station. Based on the first service information and the second service information, the first base station can determine the time segment configuration information. The method of the first base station to determine the time segment configuration information based on the first service information and the second service information is similar to the method of the second base station to determine the time segment configuration information and is not repeated here.

It will be understood that the above embodiments are illustrative of a process of negotiation between the first base station and the second base station. In practice, multiple interactions may also be included for information confirmation, and so on, which will not be repeated here.

FIG. 12 is a schematic flowchart illustrating a time segment configuration method according to an embodiment of the present disclosure. The time segment configuration method shown in this embodiment can be performed by a base station, the base station includes, but is not limited to, a 4G base station, a 5G base station, a 6G base station, or a base station of any generation of communication system. The base station may be a second base station in the above embodiments, communicating with a terminal and a first base station in the above embodiments, the terminal including but not limited to a cell phone, a tablet, a wearable device, a sensor, an IoT device, and other electronic devices. In an embodiment, the terminal may be a terminal performing a time segment request method as described in any of the above embodiments.

As shown in FIG. 12, the method further includes the following step S1201. At step S1201, time segment configuration information is transmitted to the terminal.

The time segment configuration information is for indicating that the terminal controls a first SIM to communicate with a first base station and controls a second SIM to communicate with a second base station based on the time segment configuration information when determining that the second SIM is to communicate with the second base station during communication between the first SIM and the first base station.

In an embodiment, the second base station may transmit time segment configuration information to the terminal. After receiving the time segment configuration information, the terminal may process a situation in which that the second SIM needs to communicate with the second base station is determined during the communication between the first base station and the first SIM based on the time segment configuration information. Specifically, during the communication between the first SIM and the first base station, in response to determining that the second SIM is to communicate with the second base station, the terminal controls the first SIM to communicate with the first base station and controls the second SIM to communicate with the second base station based on the time segment configuration information.

Accordingly, in a process of communication between a first SIM and a first base station, when determining that a second SIM is to communicate with a second base station, a terminal can implement both the communication between the first base station and the first SIM and communication between the second base station and the second SIM within a period of time according to time segment configuration information, and it is not necessary to completely interrupt a communication connection between the first SIM and the first base station in order to communicate with the second base station via the second SIM, which is conducive to improving communication efficiency of the terminal.

FIG. 13 is a schematic flowchart illustrating another time segment configuration method according to an embodiment of the present disclosure.

As shown in FIG. 13, time segment configuration information is transmitted to a terminal includes the following step S1301. At step S1301, in response to determining that a request for obtaining the time segment configuration information is received from the terminal, the time segment configuration information is transmitted to the terminal.

In an embodiment, the terminal may transmit the request for obtaining the time segment configuration information to the second base station via the second SIM. After receiving the request, the second base station transmits the time segment configuration information to the terminal. Or, the second base station may further transmit a negotiation request to a first base station, causing the first base station to transmit the time segment configuration information to the terminal. Or, the second base station may also transmit the time segment configuration information to the terminal based on a returned negotiation result after transmitting the negotiation request to the first base station.

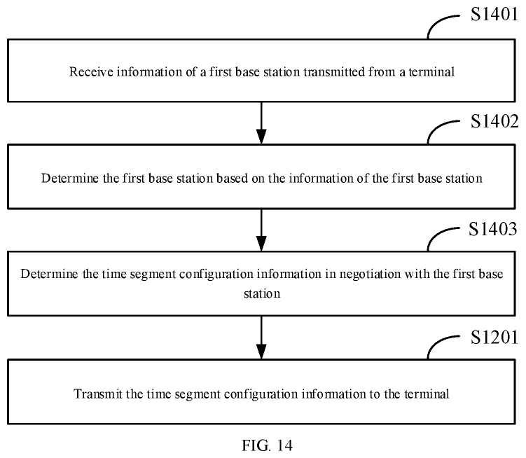

FIG. 14 is a schematic flowchart illustrating another time segment configuration method according to an embodiment of the present disclosure.

As shown in FIG. 14, the method further includes the following steps S1401-S1403 along with step S1201.

At step S1401, information of a first base station transmitted from a terminal is received.

In an embodiment, a base station may negotiate with another base station in order to determine a time segment. After receiving a request for obtaining time segment configuration information, a second base station needs to negotiate with the first base station. To negotiate with the first base station, the second base station first needs to establish communication with the first base station, so it is also necessary to obtain information of the first base station from the terminal. In an embodiment, the terminal can transmit the information of the first base station to the second base station via the second SIM, and the second base station receives the information of the first base station transmitted from the terminal.

Optionally, the terminal may carry the information of the first base station in the request for obtaining the time segment configuration information; or, the terminal may also transmit the information of the first base station via a separate signaling.

In an embodiment, the information of the first base station includes at least one of: an ID of the base station, a communication technology type of the base station, or configuration information of the base station.

At step S1402, the first base station is determined based on the information of the first base station.

In an embodiment, after receiving the information of the first base station, the second base station may determine the first base station indicated by the information. Optionally, if the second base station determines that the first base station and the second base station are a same base station, the time segment configuration information may be determined directly.

At step S1403, the time segment configuration information is determined in negotiation with the first base station.

In an embodiment, after receiving the information of the first base station, the second base station may determine the first base station indicated by the information of the first base station, then establish a communication connection with the first base station, and negotiate with the first base station to determine the time segment configuration information. In this way, the first base station and/or the second base station may send the time segment configuration information to the terminal.

The specific implementation of the above steps can be referred to the steps performed by the first base station in FIG. 8 and will not be repeated here.

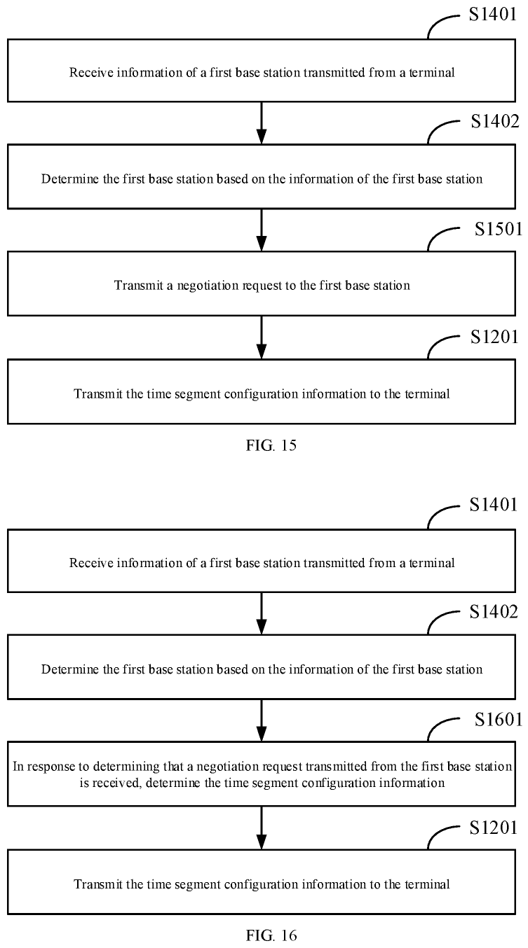

FIG. 15 is a schematic flowchart illustrating another time segment configuration method according to an embodiment of the present disclosure.

As shown in FIG. 15, the time segment configuration information is determined in negotiation with the first base station includes the following step S1501 along with steps S1401, S1402 and S1201.

At step S1501, a negotiation request is transmitted to the first base station.

The negotiation request is for requesting the first base station to determine the time segment configuration information.

In an embodiment, after receiving information of the first base station from a terminal, if a second base station determines that the first base station is not a same base station as the second base station, the second base station may establish a communication connection with the first base station and then transmit a negotiation request to the first base station, after the first base station receives the negotiation request, the time segment configuration information may be determined.

In an embodiment, the second base station may also transmit second service information corresponding to communication between a second SIM and the second base station to the first base station, and the negotiation request is for requesting the first base station to determine the time segment configuration information based on the second service information, and first service information corresponding to communication between a first SIM and the first base station.

The specific implementation of the second base station transmitting the negotiation request to the first base station can be referred to the steps of the first base station transmitting the negotiation request to the second base station shown in FIG. 9, which will not be repeated here.

FIG. 16 is a schematic flowchart illustrating another time segment configuration method according to an embodiment of the present disclosure.

As shown in FIG. 16, the time segment configuration information is determined in negotiation with the first base station includes the following step S1601 along with steps S1401, S1402 and S1201.

At step S1601, in response to determining that a negotiation request transmitted from the first base station is received, the time segment configuration information is determined.

In an embodiment, after receiving information of a second base station from a terminal, if the first base station determines that the first base station and the second base station are not a same base station, the first base station may establish a communication connection with the second base station and thus transmit a negotiation request to the second base station. After receiving the negotiation request, the second base station may determine the time segment configuration information.

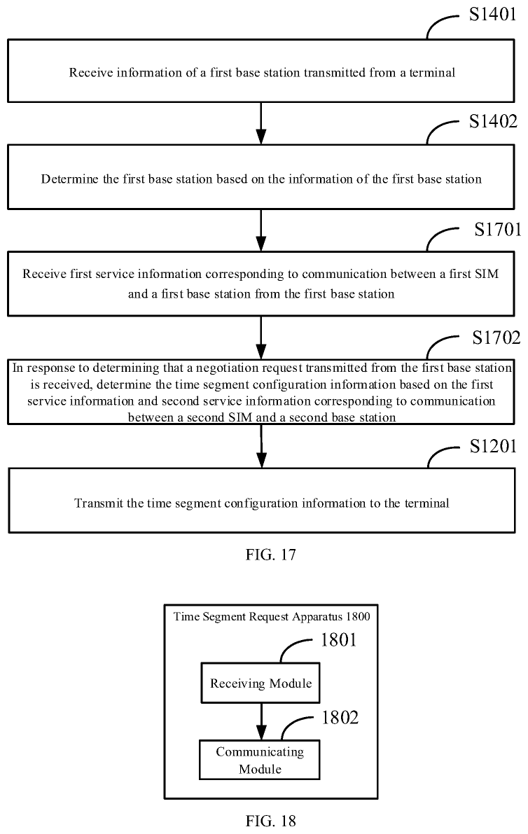

FIG. 17 is a schematic flowchart illustrating another time segment configuration method according to an embodiment of the present disclosure.

As shown in FIG. 17, the method further includes the following steps S1701 and S1702 along with steps S1401, S1402 and S1201.

At step S1701, first service information corresponding to communication between a first SIM and a first base station is received from the first base station.

Determining time segment configuration information includes the following.

At step S1702, the time segment configuration information is determined based on the first service information and second service information corresponding to communication between a second SIM and a second base station.

It is understood that the method of the second base station to determine the time segment configuration information based on the first service information and the second service information is similar to the method of the first base station to determine the time segment configuration information and is not repeated here.

Corresponding to the aforementioned embodiments of the time segment request methods, the present disclosure also provides embodiments of time segment request apparatuses.

FIG. 18 is a schematic block diagram illustrating a time segment request apparatus 1800 according to an embodiment of the present disclosure. The time segment request apparatus 1800 shown in this embodiment may be performed by a terminal, and the terminal includes, but is not limited to, electronic devices such as cell phones, tablets, wearable devices, sensors, IoT devices and so on. The terminal may communicate with a base station as a user equipment, and the base station includes, but is not limited to, a 4G base station, a 5G base station, a 6G base station, or a base station of any generation of communication system. In an embodiment, the base station may be a base station to which a time segment configuration apparatus described in any of the subsequent embodiments is applied.

With at least a first SIM and a second SIM configured in the terminal, the terminal can be considered as a multi-SIM terminal. For example, the terminal can be selectively implemented as multi-SIM-multi-standby, multi-SIM-single-active, multi-SIM-multi-active, and so on. The multiple SIMS can access a network of the same operator or networks of different operators, which can be configured as needed.

As shown in FIG. 18, the time segment request apparatus 1800 may include a receiving module 1801 and a communicating module 1802.

A receiving module 1801 is configured to receive time segment configuration information from a network side device.

A communicating module 1802 is configured to control a first SIM to communicate with a first base station and control a second SIM to communicate with a second base station based on the time segment configuration information, in response to determining that the second SIM is to communicate with the second base station during communication between the first SIM and the first base station.

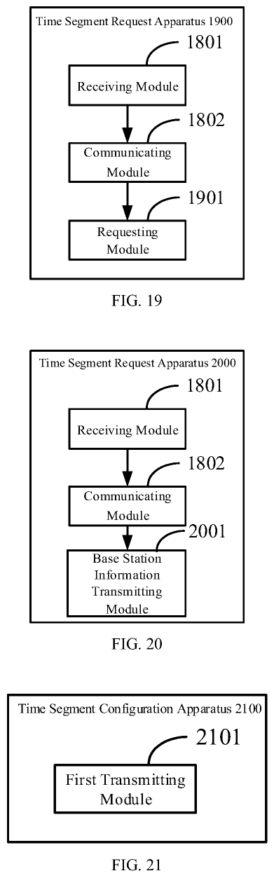

FIG. 19 is a schematic block diagram illustrating a time segment request apparatus 1900 according to an embodiment of the present disclosure. As shown in FIG. 19, the apparatus 1900 includes the receiving module 1801 and the communicating module 1802 and further includes a requesting module 1901, configured to transmit a request for obtaining time segment configuration information to the first base station via the first SIM, and/or to transmit the request to the second base station via the second SIM.

Optionally, transmitting the request for obtaining the time segment configuration information to the first base station via the first SIM, and/or transmitting the request to the second base station via the second SIM includes the following.

In response to determining that the second SIM is to communicate with the second base station during communication between the first SIM and the first base station, transmitting a request for obtaining the time segment configuration information to the first base station via the first SIM, and/or transmitting the request to the second base station via the second SIM.

FIG. 20 is a schematic block diagram illustrating a time segment request apparatus 2000 according to an embodiment of the present disclosure. As shown in FIG. 20, the apparatus 2000 includes the receiving module 1801 and the communicating module 1802 and further includes a base station information transmitting module 2001.

A base station information transmitting module 2001 is configured to transmit information of a second base station to a first base station via a first SIM; and/or to transmit information of the first base station to the second base station via a second SIM.

Optionally, the base station information transmitting module is further configured to transmit the information of the second base station to the first SIM via the second SIM; and/or to transmit the information of the first base station to the second SIM via the first SIM.

Optionally, the information of the first base station and/or the information of the second base station includes at least one of: an identifier (ID) of the base station, a communication technology type of the base station, or configuration information of the base station.

Optionally, based on the time segment configuration information, controlling the first SIM to communicate with the first base station, and controlling the second SIM to communicate with the second base station includes the following.

Determining a target time segment based on the time segment configuration information.

Controlling the second SIM to communicate with the second base station within the target time segment and controlling the first SIM to communicate with the first base station outside the target time segment.

Or, controlling the first SIM to communicate with the first base station within the target time segment and controlling the second SIM to communicate with the second base station outside the target time segment.

Corresponding to the aforementioned embodiments of the time segment configuration methods, the present disclosure also provides embodiments of time segment configuration apparatuses.

FIG. 21 is a schematic block diagram illustrating a time segment configuration apparatus 2100 according to an embodiment of the present disclosure. The time segment configuration apparatus 2100 shown in this embodiment can be applied to a base station, the base station includes, but is not limited to, a 4G base station, a 5G base station, a 6G base station, or a base station of any generation of communication system. The base station may be a first base station in the above embodiments, communicating with a terminal and a second base station in the above embodiments, the terminal including but not limited to a cell phone, a tablet, a wearable device, a sensor, an IoT device, and other electronic devices.

As shown in FIG. 21, the apparatus 2100 includes a first transmitting module 2101.

A first transmitting module 2101 is configured to transmit time segment configuration information to a terminal.

The time segment configuration information is for indicating that the terminal controls a first SIM to communicate with a first base station and controls a second SIM to communicate with a second base station based on the time segment configuration information when determining that the second SIM is to communicate with the second base station during communication between the first SIM and the first base station.

Optionally, transmitting the time segment configuration information to the terminal, includes: in response to determining that a request for obtaining the time segment configuration information is received from the terminal, transmitting the time segment configuration information to the terminal.

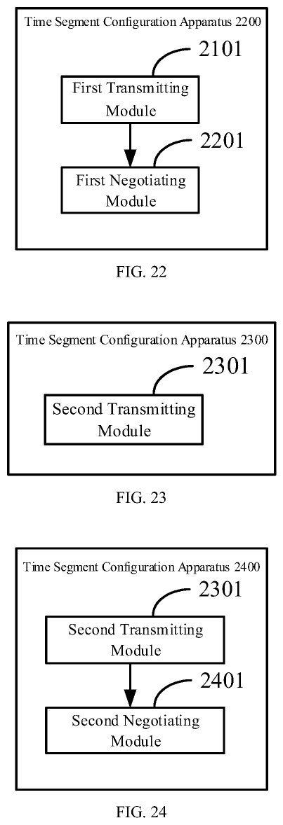

FIG. 22 is a schematic block diagram illustrating another time segment configuration apparatus 2200 according to an embodiment of the present disclosure.

As shown in FIG. 22, the apparatus 2200 further includes a first negotiating module 2201 along with the first transmitting module 2101.

A first negotiating module 2201 is configured to receive information of a second base station transmitted from a terminal; determine the second base station based on the information of the second base station; and determine the time segment configuration information in negotiation with the second base station.

Optionally, determining the time segment configuration information in negotiation with the second base station, includes: transmitting a negotiation request to the second base station, where the negotiation request is for requesting the second base station to determine the time segment configuration information.

Optionally, the first negotiating module 2201 is further configured to transmit first service information corresponding to communication between a first SIM and a first base station to the second base station; and the negotiation request is for requesting the second base station to determine the time segment configuration information based on the first service information, and second service information corresponding to communication between a second SIM and the second base station.

Optionally, determining the time segment configuration information in negotiation with the second base station, including: in response to determining that the negotiation request transmitted by the second base station is received, determining the time segment configuration information.

Optionally, the first negotiating module 2201 is further configured to receive the second service information corresponding to communication between the second SIM and the second base station from the second base;

Determining the time segment configuration information includes: determining the time segment configuration information based on the second service information, and the first service information corresponding to the communication between the first SIM and the first base station.

Corresponding to the aforementioned embodiments of the time segment configuration methods, the present disclosure also provides embodiments of other time segment configuration apparatuses.

FIG. 23 is a schematic block diagram illustrating a time segment configuration apparatus 2300 according to an embodiment of the present disclosure. The time segment configuration apparatus 2300 shown in this embodiment can be applied to a base station, the base station includes, but is not limited to, a 4G base station, a 5G base station, a 6G base station, or a base station of any generation of communication system. The base station may be a second base station in the above embodiments, communicating with a terminal and a first base station in the above embodiments, the terminal including but not limited to a cell phone, a tablet, a wearable device, a sensor, an IoT device, and other electronic devices.

As shown in FIG. 23, the apparatus 2300 includes a second transmitting module 2301.

The second transmitting module 2301 is configured to transmit time segment configuration information to a terminal.

The time segment configuration information is for indicating that the terminal controls a first SIM to communicate with a first base station and controls a second SIM to communicate with a second base station based on the time segment configuration information when determining that the second SIM is to communicate with the second base station during communication between the first SIM and the first base station.

Optionally, transmitting the time segment configuration information to the terminal, includes: in response to determining that a request for obtaining the time segment configuration information is received from the terminal, transmitting the time segment configuration information to the terminal.

FIG. 24 is a schematic block diagram illustrating a time segment configuration apparatus 2400 according to an embodiment of the present disclosure. As shown in FIG. 24, the apparatus includes the second transmitting module 2301 and further includes a second negotiating module 2401.

The second negotiating module 2401 is configured to: receive information of a first base station transmitted from a terminal; determine the first base station based on the information of the first base station; and determine the time segment configuration information in negotiation with the first base station.

Optionally, determining the time segment configuration information in negotiation with the first base station, includes: transmitting a negotiation request to the first base station.

The negotiation request is for requesting the first base station to determine the time segment configuration information.

Optionally, the second negotiating module 2401 is further configured to transmit second service information corresponding to communication between a second SIM and a second base station to the first base station.

The negotiation request is for requesting the first base station to determine the time segment configuration information based on the second service information, and first service information corresponding to communication between a first SIM and the first base station.

Optionally, determining the time segment configuration information in negotiation with the second base station, includes: in response to determining that the negotiation request transmitted by the first base station is received, determining the time segment configuration information.

Optionally, the second negotiating module 2401 is further configured to receive the first service information corresponding to the communication between the first SIM and the first base station transmitted from the first base station.

Determining the time segment configuration information includes: determining the time segment configuration information based on the first service information, and the second service information corresponding to the communication between the second SIM and the second base station.

With regard to the device in the above embodiments, the specific manner in which the respective modules perform the operations has been described in detail in the embodiments of the related methods, and will not be explained in detail herein.

For the embodiments of the apparatus, since they basically correspond to the embodiments of the method, they may be referred to the partial description of the embodiments of the method. The apparatus embodiments described above are only schematic, and the modules described as separate components may or may not be physically separated, and the components displayed as modules may or may not be physical modules, that is, may be located in one place, or can be distributed to multiple network modules. Part or all of the modules may be selected according to actual requirements to implement the objectives of the solutions in the examples. Those of ordinary skill in the art can understand and implement the present disclosure without any creative effort.

An embodiment of the present disclosure further provides an electronic device, including: a processor, and a memory for storing processor-executable instructions; where the processor is configured to implement the time segment request methods and/or the time segment configuration methods according to any of the embodiments as described above.

The electronic device can be either a terminal or a base station.

Embodiments of the present disclosure also provide a computer readable storage medium having a computer program stored thereon, where the program, when executed by a processor, implements the steps in the time segment request method and/or the time segment configuration method described in any of the above examples.

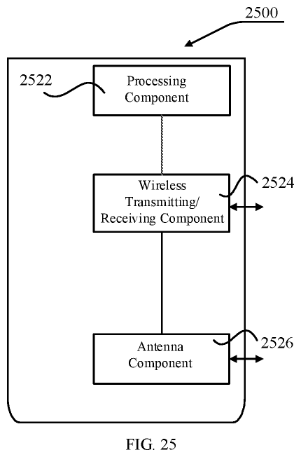

As shown in FIG. 25, FIG. 25 is a schematic block diagram illustrating an apparatus 2500 for time segment configuration according to an embodiment of the present disclosure. The apparatus 2500 may be provided as a base station. Referring to FIG. 25, the apparatus 2500 includes a processing component 2522, a wireless transmitting/receiving component 2524, an antenna component 2526, and a signal processing portion specific to a wireless interface. The processing component 2522 may further include one or more processors. One of the processors in the processing component 2522 may be configured to implement steps in a time segment configuration method according to any of the examples as described above.

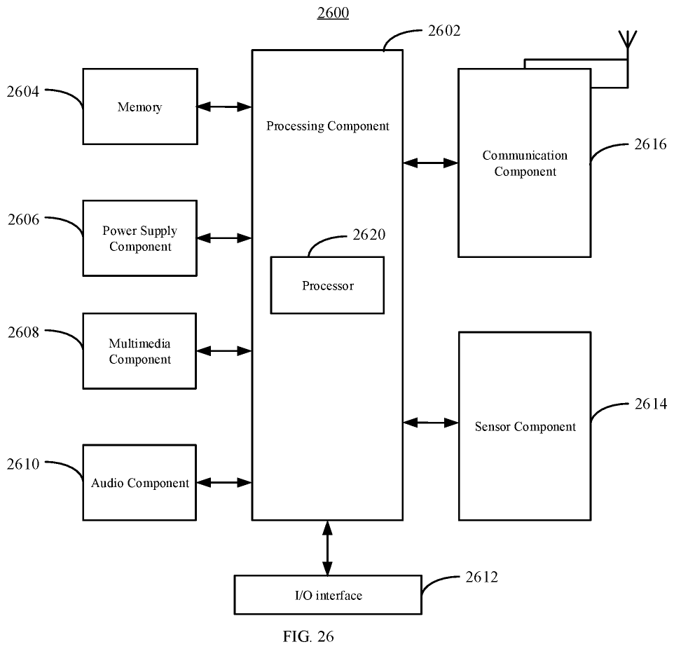

FIG. 26 is a schematic block diagram illustrating an apparatus 2600 for time segment request according to an embodiment of the present disclosure. For example, device 2600 can be a mobile phone, a computer, a digital broadcast terminal, a message transmitting and receiving device, a gaming console, a tablet device, a medical device, a fitness device, a personal digital assistant, and the like.

Referring to FIG. 26, device 2600 can include one or more of the following components: processing component 2602, memory 2604, power supply component 2606, multimedia component 2608, audio component 2610, input/output (I/O) interface 2612, sensor component 2614, and a communication component 2616.

The processing component 2602 usually controls overall operations of the apparatus 2600, such as operations related to display, a telephone call, data communication, a camera operation and a record operation. The processing component 2602 may include one or more processors 2620 to execute instructions to complete all or a part of the steps of the above methods. In addition, the processing component 2602 may include one or more modules which facilitate the interaction between the processing component 2602 and other components. For example, the processing component 2602 may include a multimedia module to facilitate the interaction between the multimedia component 2608 and the processing component 2602.

The memory 2604 is configured to store different types of data to support the operations of the electronic device 2600. Examples of such data include instructions, contact data, phonebook data, messages, pictures, videos, and so on for any application or method that operates on the apparatus 2600. The memory 2604 may be implemented by any type of volatile or non-volatile storage devices or a combination of the above, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 2606 provides power for different components of the electronic device 2600. The power supply component 2606 may include a power management system, one or more power sources, and other components associated with generating, managing and distributing power for the electronic device 2600.

The multimedia component 2608 includes a screen for providing an output interface between the apparatus 2600 and a user. In some examples, the screen may include a Liquid Crystal Display (LCD) and a Touch Panel (TP) and so on. If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a duration and a pressure associated with the touch or swipe. In some examples, the multimedia component 2608 may include a front camera and/or a rear camera. When the device 2600 is in an operation mode, such as a shooting mode or a video mode, the front camera and/or the rear camera can receive external multimedia data. Each of the front camera and the rear camera may be a fixed optical lens system or have focal length and optical zooming capability.

The audio component 2610 is configured to output and/or input an audio signal. For example, the audio component 2610 may include a microphone (MIC). When the electronic device 2600 is in an operating mode, such as a call mode, a recording mode and a speech recognition mode, the microphone is configured to receive an external audio signal. The received audio signal may be further stored in the memory 2604 or sent via the communication component 2616. In some examples, the audio component 2610 may also include a loudspeaker for outputting an audio signal.

The I/O interface 2612 provides an interface between the processing component 2602 and a peripheral interface module. The above peripheral interface module may be a keyboard, a click wheel, a button, or the like. These buttons may include but not limited to, a home button, a volume button, a start button and a lock button.

The sensor component 2614 includes one or more sensors for providing state assessments in different aspects for the apparatus 2600. For example, sensor component 2614 can detect an open/closed state of device 2600, a relative positioning of components, such as the display and keypad of device 2600, and sensor component 2614 can also detect a change in position of device 2600 or a component of device 2600, the presence or absence of user contact with device 2600, orientation or acceleration/deceleration of device 2600, and temperature change of device 2600. The sensor component 2614 may include a proximity sensor for detecting the existence of a nearby object without any physical touch. The sensor component 2614 may also include a Complementary Metal-Oxide-Semiconductor (CMOS) or Charged Coupled Device (CCD) image sensor applied in an imaging application. In some examples, the sensor component 2614 may also include an acceleration sensor, a gyro sensor, a magnetic sensor, a pressure sensor, a temperature sensor, or the like.

The communication component 2616 is configured to facilitate wired or wireless communication between the apparatus 2600 and other devices. The apparatus 2600 may access a wireless network based on a communication standard, such as Wi-Fi, 2G or 3G, 4G LTE, 5G NR or a combination of the above. In some examples, the communication component 2616 receives a broadcast signal or broadcast related information from an external broadcast management system via a broadcast channel. In an example, the communication component 2616 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the apparatus 2600 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the time segment request method in any one of the above examples.

In an example, there is also provided a non-transitory computer readable storage medium including instructions, such as a memory 2604 including instructions executable by a processor 2620 of device 2600 to perform the above time segment request method. For example, the non-transitory computer-readable storage medium may be a ROM, a RAM, a CD-ROM, a magnetic tape, a floppy disc, an optical data storage device, and the like.

A person skilled in the art can easily figure out another implementation solution of the disclosure after considering the specification and practicing the disclosure that is disclosed herein. The present disclosure is intended to cover any variations, uses, modification or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes can be made without departing from the scope thereof. The scope of the present disclosure is limited only by the appended claims.

It is to be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more restrictions, the elements defined by the sentence “including a . . . ” do not exclude the existence of other identical elements in the process, method, product, apparatus or device including the elements.

The methods and apparatuses of the present disclosure are described above in detail. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1. A time segment request method, performed by a terminal configured with at least a first Subscriber Identity Module (SIM) and a second SIM, the method comprising:
receiving time segment configuration information from a network side device; and
in response to determining that the second SIM is to communicate with a second base station during communication between the first SIM and a first base station, controlling the first SIM to communicate with the first base station and controlling the second SIM to communicate with the second base station, based on the time segment configuration information.

2. The method according to claim 1, further comprising at least one of:
transmitting a request for obtaining the time segment configuration information to the first base station via the first SIM or transmitting the request to the second base station via the second SIM.

3. The method according to claim 2, wherein at least one of transmitting the request for obtaining the time segment configuration information to the first base station via the first SIM or transmitting the request to the second base station via the second SIM comprises:
in response to determining that the second SIM is to communicate with the second base station during the communication between the first SIM and the first base station, transmitting the request for obtaining the time segment configuration information to the first base station via the first SIM, or
transmitting the request to the second base station via the second SIM, or
transmitting the request for obtaining the time segment configuration information to the first base station via the first SIM and transmitting the request to the second base station via the second SIM.

4. The method according to claim 1, further comprising at least one of:
transmitting information of the second base station to the first base station via the first SIM; or
transmitting information of the first base station to the second base station via the second SIM,
wherein at least one of the information of the first base station or the information of the second base station comprises at least one of:
an identifier of a corresponding base station, a communication technology type of the corresponding base station, or configuration information of the corresponding base station.

5. The method according to claim 4, further comprising at least one of:
transmitting the information of the second base station to the first SIM via the second SIM; or
transmitting the information of the first base station to the second SIM via the first SIM.

6. (canceled)

7. The method according to claim 1, wherein controlling the first SIM to communicate with the first base station and controlling the second SIM to communicate with the second base station, based on the time segment configuration information comprises:
determining a target time segment based on the time segment configuration information; and
controlling the second SIM to communicate with the second base station within the target time segment and controlling the first SIM to communicate with the first base station outside the target time segment; or
controlling the first SIM to communicate with the first base station within the target time segment and controlling the second SIM to communicate with the second base station outside the target time segment.

8. A time segment configuration method, performed by a first base station, comprising:
transmitting time segment configuration information to a terminal,
wherein the time segment configuration information is for indicating that the terminal controls a first Subscriber Identity Module (SIM) to communicate with the first base station and controls a second SIM to communicate with a second base station based on the time segment configuration information in response to determining that the second SIM is to communicate with the second base station during communication between the first SIM and the first base station.

9. The method according to claim 8, wherein transmitting the time segment configuration information to the terminal comprises:
in response to determining that a request for obtaining the time segment configuration information is received from the terminal, transmitting the time segment configuration information to the terminal.

10. The method according to claim 8, further comprising:
receiving information of the second base station transmitted from the terminal;
determining the second base station based on the information of the second base station; and
determining the time segment configuration information in negotiation with the second base station, comprising
transmitting a negotiation request to the second base station,
wherein the negotiation request is for requesting the second base station to determine the time segment configuration information.

11. (canceled)

12. The method according to claim 10, further comprising:
transmitting first service information corresponding to the communication between the first SIM and the first base station to the second base station,
wherein the negotiation request is for requesting the second base station to determine the time segment configuration information based on the first service information and second service information corresponding to communication between the second SIM and the second base station.

13. The method according to claim 10, wherein determining the time segment configuration information in negotiation with the second base station comprises:
in response to determining that a negotiation request transmitted from the second base station is received, determining the time segment configuration information.

14. The method according to claim 13, further comprising:
receiving second service information corresponding to communication between the second SIM and the second base station from the second base,
wherein determining the time segment configuration information comprises:
determining the time segment configuration information based on the second service information and first service information corresponding to the communication between the first SIM and the first base station.

15. A time segment configuration method, performed by a second base station, comprising:
transmitting time segment configuration information to a terminal,
wherein the time segment configuration information is for indicating that the terminal controls a first Subscriber Identity Module (SIM) to communicate with a first base station and controls a second SIM to communicate with the second base station based on the time segment configuration information in response to determining that the second SIM is to communicate with the second base station during communication between the first SIM and the first base station.

16. The method according to claim 15, wherein transmitting the time segment configuration information to the terminal comprises:
in response to determining that a request for obtaining the time segment configuration information is received from the terminal, transmitting the time segment configuration information to the terminal.

17. The method according to claim 16, further comprising:
receiving information of the first base station transmitted from the terminal;
determining the first base station based on the information of the first base station; and
determining the time segment configuration information in negotiation with the first base station, comprising:
transmitting a negotiation request to the first base station,
wherein the negotiation request is for requesting the first base station to determine the time segment configuration information.

18. (canceled)

19. The method according to claim 17, further comprising:
transmitting second service information corresponding to communication between the second SIM and the second base station to the first base station,
wherein the negotiation request is for requesting the first base station to determine the time segment configuration information based on the second service information, and first service information corresponding to the communication between the first SIM and the first base station.

20. The method according to claim 17, wherein determining the time segment configuration information in negotiation with the first base station comprises:
in response to determining that a negotiation request transmitted from the first base station is received, determining the time segment configuration information.

21. The method according to claim 17, further comprising:
receiving first service information corresponding to the communication between the first SIM and the first base station transmitted from the first base station,
wherein determining the time segment configuration information comprises:
determining the time segment configuration information based on the first service information and second service information corresponding to communication between the second SIM and the second base station.

22-24. (canceled)

25. An electronic device, comprising:
a processor, and
a memory for storing processor-executable instructions,
wherein the processor is configured to implement the time segment request method according to claim 1.

26. A non-transitory computer readable storage medium storing a computer program, wherein the program is executed by a processor to perform the time segment request method according to claim 1.
